(19) United States
(12) Patent Application Publication
(10) Pub. No.: US 2005/0271778 A1
(43) Pub. Date: Dec. 8, 2005

(54) Method for producing coated pharmaceuticals and food supplements with concentration gradients in the coating thereof

(75) Inventors: Hans-Ulrich Petereit, Darmstadt (DE); Christian Meier, Darmstadt (DE); Erna Roth, Darmstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Roehm GMBH & Co., KG, Darmstadt (DE)

(21) Appl. No.: 10/539,614

(22) PCT Filed: Oct. 18, 2003
(86) PCT No.: PCT/EP03/11540

§ 371 Date: Jun. 17, 2005

(30) Foreign Application Priority Data
Dec. 20, 2002 (DE) 102 60 919.5

(51) Int. Cl. A23B 4/00

(52) U.S. Cl. 426/302

(57) ABSTRACT

The invention relates to a method for producing pharmaceuticals or parts thereof or food supplements or parts thereof, by coating substrates for pharmaceutical uses or for using as food supplements for humans or animals, with a film-forming coating agent mixed with at least one other substance suitable for the cited purposes. The film-forming coating agent and the other substance first constitute separate liquid, sprayable individual portions, and are sprayed by means of at least one spray device which are provided, individually or together, with at least two separate nozzles for liquids, and have overlapping spray jets—in such a way that the individual portions sprayed out of the separate nozzles mix during the spraying process and the mixture forms a continuous film coating on the substrate, forming the food supplement, the pharmaceutical or the part thereof. The invention is characterized in that the coating agent and the other substance are in a concentration gradient from the inside to the outside.

The invention relates to a method for producing coated pharmaceuticals and food supplements with concentration gradients in the coating

### PRIOR ART

Abletshauser C. B., describes in “Film coating of pellets with insoluble polymers obtained in situ crosslinking in fluidized bed” in Journal of Controlled Release 27 (1993), pp. 149-156, a method in which a film-forming polymer, sodium alginate, in aqueous solution and a crosslinker, e.g. a CaCl₂ solution or a (meth)acrylate copolymer with tertiary amino group radicals (EUDRAGIT E®), are sprayed simultaneously from two separate spray nozzles onto active ingredient-containing pellets. The film application can take place for example in a fluidized bed apparatus with two spray nozzles installed therein. The method has an approximately equivalent result to sequential application of the two components, but has the advantage of saving time.

WO 00/05307 describes a method for producing a coating agent and binder for oral or dermal pharmaceuticals consisting of (a) 35-98% by weight of a copolymer consisting of free-radical polymerized C1 to C4 esters of acrylic or methacrylic acid and further (meth)acrylate monomers which have functional tertiary ammonium groups, and (b) 1-50% by weight of a plasticizer, and 1-15% by weight of an emulsifier with an HLB of at least 14, where components (a), (b) and (c) are mixed together with or without addition of water and, where appropriate, with addition of an active pharmaceutical ingredient and further conventional additives, and the coating agent and binder is produced by melting, casting, spreading or spraying, where the copolymer (a) is introduced in powder form with an average particle size of 1-40 μm.

Additives which can be incorporated are pigments. Ordinarily, aluminum or iron oxide pigments are dispersed. The usual amounts of pigments employed are between 20 and 60% by weight based on the polymer mixture. However, because of the high pigment-binding capacity, amounts of up to 100% by weight can also be processed.

In a preferred embodiment, the addition of pigments takes place in concentrated form as final layer. Application takes place by spraying as powder or from aqueous suspension with a solids content of 5-30%. The amount required is lower than on incorporation into the polymer layer and is 0.1-2% based on the weight of the pharmaceutical.

EP-A 0 848 960 describes an adhesive and binder for dermal or transdermal therapeutic systems consisting of (a1) 55-99.9% by weight of a (meth)acrylate copolymer of structural and functional monomers, where the functional monomers have tertiary or quaternary amino groups, (a2) 0.1-45% by weight of an acidic group-containing acrylate or (meth)acrylate polymer or copolymer and (b) 25-80% by weight, based on the total of (a1) and (a2), of a plasticizer. A transdermal therapeutic system can be produced by incorporating an active pharmaceutical ingredient by coating or by spraying or painting of solutions, dispersions, suspensions or melts of an adhesive and binder and subsequently drying or cooling.

Problem and Solution

There is a constant demand for formulations for pharmaceuticals or parts thereof with whose aid it is possible to administer onto novel or known active ingredients with specific release profiles. Mixed coatings of two or more mutually interactive components have proved to be helpful and very flexible. Thus, for example, active ingredient release from (meth)acrylate copolymer coatings can be considerably influenced by the addition of substances such as organic acids or emulsifiers and be controlled within desired ranges. Likewise, mixtures of two (meth)acrylate copolymer types which have release profiles which are very different on their own and which open up new applications in combination are known.

One disadvantage of many of these combinations is inter alia that incompatibilities of the components with one another or incompatibilities with the active ingredient present in the pharmaceutical may occur.

The problem was regarded as being to provide a method for producing pharmaceuticals or parts of pharmaceuticals that makes it possible to utilize the properties of mixed coatings of mutually interactive, i.e. mutually influencing components but at the same time substantially to reduce or to avoid problems with incompatibilities.

The problem is solved by a method for producing pharmaceuticals or parts of pharmaceuticals or food supplements or parts thereof
by coating substrates for pharmaceutical applications or substrates for applications as food supplements for humans or animals with a film-forming coating agent which is mixed with at least one further substance suitable for said purposes,
where the film-forming coating agent and the further substance are initially present separate from one another as liquid, sprayable individual portions in the form of a solution or dispersion, and
are sprayed by means of one or more spray devices which have, singly or together, at least two separate nozzles for liquids, and their spray beams overlap,
in such a way that the individual portions sprayed from the separate nozzles are mixed during the spraying process, the mixture impinges on the substrate and forms thereon, after evaporation of the liquid, a continuous film coating, resulting in the pharmaceutical, the food supplement or the part thereof,
characterized in that
the amounts of the individual portions are varied during the spraying process so that the coating agent and the further substance are present in a concentration gradient from the inside to the outside relative to the dried film coating.
   Implementation of the Invention

The invention relates to a method for producing pharmaceuticals or parts of pharmaceuticals or food supplements or parts thereof,
by coating substrates for pharmaceutical applications with a film-forming coating agent which is mixed with at least one further substance suitable for said purposes,
where the film-forming coating agent and the further substance are initially present separate from one another as liquid, sprayable individual portions in the form of a solution or dispersion, and
are sprayed by means of one or more spray devices which have, singly or together, at least two separate nozzles for liquids, and their spray beams overlap,
in such a way that the individual portions sprayed from the separate nozzles are mixed in the spray mist during the spraying process, the mixture impinges on the substrate and forms thereon, after evaporation of the liquid, a continuous film coating, resulting in the pharmaceutical, the food supplement or the part thereof,
characterized in that
the amounts of the individual portions are varied during the spraying process so that the coating agent and the further substance are present in a concentration gradient from the inside to the outside relative to the dried film coating.
   Film-Forming Coating Agent

Film-forming coating agents mean for the purposes of the invention all pharmaceutically usable polymeric coating agents such as, for example, cellulose derivatives or (meth)acrylate copolymers. The film-forming coating agent may, apart from the further substance with which the gradient mixture is generated, also comprise further pharmaceutical excipients such as, for example, plasticizers and/or an active pharmaceutical ingredient. The film-forming coating agent may be in the form of an organic solution or preferably in the form of a dispersion.

The film-forming coating agent is preferably a (meth)acrylate copolymer.

(Meth)acrylate copolymers

(EUDRAGIT® L, S, FS and NE Types)

The (meth)acrylate copolymer consists of 40 to 100, preferably 45 to 99, in particular 85 to 95, % by weight of free-radical polymerized C₁ to C₄ alkyl esters of acrylic or methacrylic acid and may comprise 0 to 60, preferably 1 to 55, in particular 5 to 15, % by weight of (meth)acrylate monomers having an anionic group in the alkyl radical.

Normally, the proportions mentioned add up to 100% by weight. However, small amounts in the range from 0 to 10, e.g. 1 to 5, % by weight of further vinylically copolymerizable monomers such as, for example, hydroxyethyl methacrylate or hydroxyethyl acrylate may additionally be present without this leading to an impairment or alteration of the essential properties.

C₁ to C₄ alkyl esters of acrylic or methacrylic acid are in particular methyl methacrylate, ethyl methacrylate, butyl methacrylate, methyl acrylate, ethyl acrylate and butyl acrylate.

A (meth)acrylate monomer having an anionic group in the alkyl radical may be for example acrylic acid, but preferably methacrylic acid.

Also suitable are anionic (meth)acrylate copolymers composed of 40 to 60% by weight methacrylic acid and 60 to 40% by weight methyl methacrylate or 60 to 40% by weight ethyl acrylate (EUDRAGIT® L or EUDRAGIT® L100-55 types).

EUDRAGIT® L is a copolymer of 50% by weight methyl methacrylate and 50% by weight methacrylic acid. EUDRAGIT® L 30D is a dispersion comprising 30% by weight EUDRAGIT® L.

EUDRAGIT® L100-55 is a copolymer of 50% by weight ethyl acrylate and 50% by weight methacrylic acid. EUDRAGIT® L 30-55 is a dispersion comprising 30% by weight EUDRAGIT® L 100-55.

Likewise suitable are anionic (meth)acrylate copolymers of 20 to 40% by weight methacrylic acid and 80 to 60% by weight methyl methacrylate (EUDRAGIT® S type).

(Meth)acrylate copolymers consisting of 10 to 30% by weight methyl methacrylate, 50 to 70% by weight methyl methacrylate and 5 to 15% by weight methacrylic acid (EUDRAGIT® FS type) are particularly well suited.

EUDRAGIT® FS is a copolymer of 25% by weight methyl methacrylate, 65% by weight methyl acrylate and 10% by weight methacrylic acid. EUDRAGIT® FS 30 D is a dispersion comprising 30% by weight EUDRAGIT® FS.

Suitable examples are neutral (meth)acrylate copolymers of 20 to 40% by weight ethyl acrylate and 60 to 80% by weight methyl methacrylate (EUDRAGIT® NE type).

EUDRAGIT® NE is a copolymer of 30% by weight ethyl acrylate and 70% by weight methyl methacrylate.

The copolymers are obtained in a manner known per se by free-radical bulk, solution, bead or emulsion polymerization. They must before processing be brought to the particle size range of the invention by suitable grinding, drying or spraying processes. This can take place by simple crushing of extruded and cooled pellets or hot cut.

The use of powders may be advantageous especially on mixture with other powders or liquids. Suitable apparatuses for producing powders are familiar to the skilled worker, e.g. air jet mills, pinned disk mills, compartment mills. It is possible where appropriate to include appropriate sieving steps. A suitable mill for industrial large quantities is, for example, an opposed jet mill (Multi No. 4200) which is operated with a gage pressure of about 6 bar.

EUDRAGIT® Type with Medium Methacrylic Acid Content

Likewise suitable are anionic (meth)acrylate copolymers of 20 to 34% by weight methacrylic acid and/or acrylic acid, 20 to 69% by weight methyl methacrylate and 0 to 40% by weight ethyl acrylate and, where appropriate, 0 to 10% by weight further monomers capable of vinylic copolymerization, with the proviso that the glass transition temperature of the copolymer according to ISO 11357-2, subsection 3.3.3, is not more than 60° C. (EUDRAGIT® type with medium methacrylic acid content)

The copolymer is composed in particular of free-radical polymerized units of
20 to 34, preferably 25 to 33, particularly preferably 28 to 32, % by weight methacrylic acid or acrylic acid, with preference for methacrylic acid,
20 to 69, preferably 35 to 65, particularly preferably 35 to 55, % by weight methyl methacrylate and, where appropriate,
0 to 40, preferably 5 to 35, particularly preferably 15 to 35, % by weight ethyl acrylate, with the proviso that the glass transition temperature of the copolymer (without added plasticizer) according to ISO 11357-2, subsection 3.3.3, is not more than 60, preferably 40 to 60, particularly preferably 45 to 55, ° C.

The (meth)acrylate copolymer preferably consists substantially to exclusively of the monomers methacrylic acid, methyl acrylate and ethyl acrylate in the quantitative proportions indicated above. The proportions mentioned ordinarily add up to 100% by weight. However, it is also possible in addition, without this leading to an impairment or alteration of the essential properties, for small amounts in the region of 0 to 10, for example 1 to 5, % by weight of further monomers capable of vinylic copolymerization, such as, for example, methyl methacrylate, butyl methacrylate, butyl acrylate or hydroxyethyl methacrylate, to be present.

Cationic (meth)acrylate copolymers

EUDRAGIT® E/EPO Types

The (meth)acrylate copolymer is composed of 30 to 80% by weight of free-radical polymerized C₁- to C₄-alkyl esters of acrylic or methacrylic acid and 70 to 20% by weight of (meth)acrylate monomers with a tertiary amino group in the alkyl radical.

Suitable monomers with functional tertiary amino groups are listed in U.S. Pat. No. 4,705,695, column 3, line 64 to column 4, line 13. Particular mention should be made of dimethylaminoethyl acrylate, 2-dimethylaminopropyl acrylate, dimethylaminopropyl methacrylate, dimethylaminobenzyl acrylate, dimethylaminobenzyl methacrylate, (3-dimethylamino-2,2-dimethyl)propyl acrylate, dimethylamino-2,2-dimethyl)propyl methacrylate, (3-diethylamino-2,2-dimethyl)propyl acrylate and diethylamino-2,2-dimethyl)propyl methacrylate. Dimethylaminoethyl methacrylate is particularly preferred.

The content of monomers with tertiary ammonium groups in the copolymer can advantageously be between 20 and 70% by weight, preferably between 40 and 60% by weight. The proportions of C₁- to C₄-alkyl esters of acrylic or methacrylic acid is 70-30% by weight. Mention should be made of methyl methacrylate, ethyl methacrylate, butyl methacrylate, methyl acrylate, ethyl acrylate and butyl acrylate.

A suitable (meth)acrylate copolymer with tertiary amino groups may be composed for example of 20-30% by weight of methyl methacrylate, 20-30% by weight of butyl methacrylate and 60-40% by weight of dimethylaminoethyl methacrylate.

A specifically suitable commercially available (meth)acrylate copolymer with tertiary amino groups is composed for example of 25% by weight of methyl methacrylate, 25% by weight of butyl methacrylate and 50% by weight of dimethylaminoethyl methacrylate (EUDRAGIT® E100).

The (meth)acrylate copolymers are obtained in a manner known per se by free-radical bulk, solution, bead or emulsion polymerization. They must before processing be brought to the particle size range of the invention by suitable grinding, drying or spraying processes.

Suitable apparatuses for producing powders are familiar to the skilled worker, e.g. air jet mills, pinned disk mills, compartment mills. It is possible where appropriate to include appropriate sieving steps. A suitable mill for industrial large quantities is, for example, an opposed jet mill (Multi No. 4200) which is operated with a gage pressure of about 6 bar.

The average particle size of the powders can be determined as follows:
By air jet sieving to divide up the ground product easily into a few fractions. This method is somewhat less exact than the alternatives in this range of measurement.
A further very suitable measurement method is laser diffraction to determine the particle size distribution. Commercially available apparatuses permit measurement in air (Malvern S3.01 particle sizer) or preferably in liquid media (LOT, Galai CIS 1). A precondition for measurement in liquids is that the polymer does not dissolve therein or the particles change in another way during the measurement. A suitable medium is, for example, a highly dilute (approx. 0.02% strength) aqueous polysorbate 80 solution.
At least 70, preferably 90, % of the particles based on the mass (mass distribution) can preferably be in the 1-40 μm size range.

(Meth)acrylate copolymers with an average particle diameter must be in the range between 1 and 40, preferably between 5 and 35, in particular between 10 and 20, μm are preferred. (EUDRAGIT® EPO type).

EUDRAGIT® RS/RL Types

Corresponding (meth)acrylate copolymers are disclosed for example in EP-A 181 515 or DE 1 617 751. They are polymers which are soluble or swellable independently of the pH and which are suitable for pharmaceutical coatings. A possible production method to be mentioned is bulk polymerization in the presence of a free-radical initiator dissolved in the monomer mixture. The polymer can also be produced likewise by solution or precipitation polymerization. The polymer can be obtained in this way in the form of a fine powder, achievable in the case of bulk polymerization by grinding and in the case of solution and precipitation polymerization for example by spray drying.

The (meth)acrylate copolymer is composed of 85 to 98% by weight of free-radical polymerized C₁- to C₄-alkyl esters of acrylic or methacrylic acid and 15 to 2% by weight of (meth)acrylate monomers with a quaternary ammonium group in the alkyl radical.

Preferred C₁- to C₄-alkyl esters of acrylic or methacrylic acid are methyl acrylate, ethyl acrylate, butyl acrylate, butyl methacrylate and methyl methacrylate.

The particularly preferred (meth)acrylate monomer with quaternary ammonium groups is 2-trimethylammoniumethyl methacrylate chloride.

A corresponding copolymer may be composed for example of 50-70% by weight of methyl methacrylate, 20-40% by weight of ethyl acrylate and 7-2% by weight of 2-trimethylammoniumethyl methacrylate chloride.

A specifically suitable copolymer contains 65% by weight of methyl methacrylate, 30% by weight of ethyl acrylate and 5% by weight of 2-trimethylammoniumethyl methacrylate chloride be composed (EUDRAGIT® RS).

A further suitable (meth)acrylate copolymer may be composed for example of 85 to less than 93% by weight of C₁- to C₄-alkyl esters of acrylic or methacrylic acid and more than 7 to 15% by weight of (meth)acrylate monomers with a quaternary ammonium group in the alkyl radical. Such (meth)acrylate monomers are commercially available and have been used for a long time for release-slowing coatings.

A specifically suitable copolymer contains for example 60% by weight of methyl methacrylate, 30% by weight of ethyl acrylate and 10% by weight of 2-trimethylammoniumethyl methacrylate chloride (EUDRAGIT® RL).

The Further Substance

The further substance for the purposes of the invention is a substance which is in any way incompatible with the film-forming coating agent, with the active ingredient present in the pharmaceutical and/or with the surroundings of the pharmaceutical. The further substance may be for example an acid, a base, a plasticizer, a release agent, a pigment, a stabilizer, an antioxidant, a further film-forming coating agent or an active pharmaceutical ingredient or a mixture thereof. The further substance is in the form of a solution or dispersion.

Applications

### GENERAL APPLICATION EXAMPLE 1

An acid-sensitive active ingredient is incompatible with (meth)acrylate copolymer comprising anionic groups but is to receive a polymeric coating of this type.

The anionic groups bring about a relatively low pH, e.g. of 2.5 to 3.0, in the dispersion. This is enough per se to bring about a chemical instability of the active ingredient. This effect can be prevented by neutralizing the acidic groups. However, a neutralization necessary to raise the pH abolishes the necessary resistance to gastric juice of the pharmaceutical. A sealing layer corresponding to the state of the art and composed of a neutral polymer, e.g. hydroxypropylmethylcellulose, would require high complexity of production and extensive analyses. The principle according to the invention achieves stabilization of the active ingredient and, at the same time, the desired resistance to gastric juice with only one coating layer. This represents a considerable simplification.

A substrate which comprises an acid-sensitive active ingredient can in this case be coated with a gradient of a coating agent which is (meth)acrylate copolymer comprising anionic groups which are wholly or partly neutralized.

(Meth)acrylate copolymer comprising anionic groups is which is neutralized less than the first-mentioned, or not at all, is employed as further substance coated, where the concentration of the further substance increases from the inside to the outside.

A substrate which comprises an acid-sensitive active ingredient can in this case also be coated with a gradient of a coating agent with (meth)acrylate copolymer comprising anionic groups, and of a base.

The base or the aqueous solution of the base is employed as further substance, with the concentration of the base decreasing from the inside to the outside. Typical bases are aqueous solutions of inorganic bases such as, for example, ammonia, alkali metal or alkaline earth metal hydroxides, such as NaOH or KOH, or organic bases such as, for example, triethanolamine.

In both cases, the anionic groups in the direct vicinity of the acid-sensitive active ingredient are neutralized so that the active ingredient is not adversely affected. The anionic (meth)acrylate copolymer is increasingly in the non-neutralized state towards the outside and can thus display for example a gastric juice-resistant effect without a harmful interaction taking place with the active ingredient.

The acid-sensitive active ingredient may be for example a protein, a peptide or a proton pump blocker, e.g. omeprazole, esomeprazole, lanzoprazole, rabeprazole, pantoprazole.

### GENERAL APPLICATION EXAMPLE 2

An alkali-sensitive active ingredient is incompatible with (meth)acrylate copolymer comprising cationic groups but is to receive a polymeric coating of this type.

In the dispersion, the cationic groups bring about a relatively high pH, e.g. of 8.0 to 9.0. This is enough per se to bring about chemical instability of the active ingredient. This effect can be prevented by neutralizing the basic groups. However, a neutralization necessary to lower the pH changes the desired pH-dependent release characteristics of the pharmaceutical. A sealing layer corresponding to the state of the art and composed of a neutral polymer, e.g. hydroxypropylmethylcellulose, would require high complexity of production and extensive analyses. The principle of the invention achieves a stabilization of the active ingredient and, at the same time, the desired pH-dependent release characteristics with only one coating layer. This represents a considerable simplification.

A substrate which comprises an alkali-sensitive active ingredient can in this case be coated with a gradient of a coating agent which is (meth)acrylate copolymer comprising cationic groups which are wholly or partly neutralized.

(Meth)acrylate copolymer comprising cationic groups is which is neutralized less than the first-mentioned, or not at all, is employed as further substance coated, where the concentration of the further substance increases from the inside to the outside.

A substrate which comprises an alkali-sensitive active ingredient can in this case also be coated with a gradient of a coating agent with (meth)acrylate copolymer comprising cationic groups, and of an acid.

The acid or the aqueous solution of the acid is employed as further substance, with the concentration of the acid decreasing from the inside to the outside. Typical acids are aqueous solutions of inorganic acids such as HCL, H₂SO₄, phosphorus acids, organic acids such as, for example, acetic acid, lactic acid, citric acid, malic acid, succinic acid etc.

In the direct vicinity of the alkali-sensitive active ingredient, the cationic groups are neutralized so that the active ingredient is not adversely affected. The cationic (meth)acrylate copolymer is increasingly in the non-neutralized state towards the outside and can thus for example contribute to a rapid release of the active ingredient in the stomach without a harmful interaction with the active ingredient taking place.

The alkali-sensitive active ingredient may be for example an analgesic, an antihistamine, a protein, or a peptide. The alkali-sensitive active ingredient may be for example acetylsalicylic acid, ranitidine or famotidine or salt thereof or a stereoisomer thereof.

### GENERAL APPLICATION EXAMPLE 3

An active ingredient sensitive to a pigment is to be provided with a polymeric coating colored with this pigment.

A substrate which comprises a pigment-sensitive active ingredient coated with a gradient of a (meth)acrylate copolymer is which comprises no or amounts of a pigment which are only non-critical for the active ingredient.

A pigment which, where appropriate, may also be mixed with a (meth)acrylate copolymer is employed as further substance in an amount which is harmful for the active ingredient, with the concentration of the pigment increasing from the inside to the outside without a harmful interaction with the active ingredient taking place.

In the direct vicinity of the alkali-sensitive active ingredient, the cationic groups are neutralized so that the active ingredient is not adversely affected. The cationic (meth)acrylate copolymer is increasingly in the non-neutralized state towards the outside and can thus for example contribute to a rapid release of the active ingredient in the stomach.

The pigment-sensitive active ingredient may be for example acetylsalicylic acid or ascorbic acid.

Substrates

The substrates for pharmaceutical applications may be for example active ingredient crystals, active ingredient-containing cores, cores without active ingredient, granules, tablets, pellets or capsules. These may be of regular or irregular shape.

The size of granules, pellets or crystals is between 0.01 and 2.5 mm, that of tablets is between 2.5 and 30.0 mm. Capsules consist for example of gelatin, starch or cellulose derivatives.

The substrates may comprise a biologically active substance (active ingredient) up to 95% and further pharmaceutical excipients up to 99.9% by weight.

Usual production processes are direct compression, compression of dry, moist or sintered granules, extrusion and subsequent rounding off, wet or dry granulation or direct pelleting (e.g. on plates) or by binding of powders (powder layering) onto active ingredient-free beads (nonpareilles) or active ingredient-containing particles.

Besides the active ingredient, further pharmaceutical excipients may be present, such as, for example, binders such as cellulose and derivatives thereof, polyvinylpyrrolidone (PVP), humectants, disintegration promoters, lubricants, disintegrants, (meth)acrylates, starch and derivatives thereof, sugar solubilizers or others.

Spray Device

It is possible to employ or use as spray device those having two or more two-fluid nozzles or one or more three-fluid nozzles.

In a two-fluid nozzle or a three-fluid nozzle, in each case one of the nozzle orifices is supplied with compressed air to atomize the liquid which is sprayed at the same time. The other or the two other spray nozzles serve to eject the respective film-forming coating agent. To carry out the method, therefore, either at least two two-fluid nozzles are required, where one in each case sprays the first film-forming coating agent and the liquid with the further substance, or a three-fluid nozzle, which sprays both simultaneously, is required.

The delivery rates of the sprayed liquids can be influenced independently of one another by the setting of parameters such as, for example, the pump outputs or the spraying pressure and/or the air delivery rates. It is possible in principle for the settings of the spray devices to be carried out manually during the spraying process. In order to obtain reproducible results, it is preferred to control the parameters which influence the delivery rates of the sprayed liquids by means of fixed programs, e.g. by electronic means.

Examples of commercially available spray devices are, for example, the Pilot SIL XII spray gun (double two-fluid nozzle; manufactured by Walther, Wuppertal, Germany), the “Concentric Dual-Feed Nozzle” model (three-fluid nozzle, manufactured by ShinEtsu, Japan) or model 946-S15 (three-fluid nozzle, manufactured by Düsen Schlick GmbH, D-96253 Untersiemau, Germany).

Spray Application

Spray application takes place by means of one or more spray devices which have, singly or together, at least two separate nozzles for liquids and whose spray beams overlap.

The film-forming coating agent and sprayable form of the further substance are sprayed in such a way that the individual portions are mixed during the spraying process, the mixture impinges on the substrate and then, after evaporation of the liquid, forms a continuous film coating, resulting in the pharmaceutical or the constituent of a pharmaceutical.

The amounts of the individual portions are varied during the spraying process so that the coating agent and the further substance are present in a concentration gradient from the inside to the outside of the dried film coating. It is not absolutely necessary for the gradient to extend over the entire coating layer thickness.

In order to ensure good mixing, the simultaneous spraying preferably takes place with a respective spraying pressure in the range from 0.6 to 2.0, preferably from 0.8 to 1.5, bar.

The spray application can take place for example in a drum coater, a coating pan, a fluidized bed apparatus or a spray sifter.

The spray application can take place using manually guided spray devices. However, better and more reproducible results are usually obtained with spray devices which are fixed installations, so that these are preferred.

Gradients

It is possible for the purposes of the invention to produce different gradients in various ways.

The gradient may, for example, have a linear configuration and extend over the entire layer thickness. The concentration of the film-forming coating agent increases continuously, and the concentration of the further substance decreases continuously, or vice versa.

The gradient may be linear but extend only over part of the layer thickness, e.g. 10 to 90% of the layer thickness, the gradient being located in the inner region of the layer, in the middle region of the layer or in the outer region of the layer. This is achieved by spraying the further substance only intermittently in increasing or decreasing amount, whereas the film-forming coating agent is sprayed throughout the spraying process. In the case where the further substance is a further film-forming coating agent, this can be sprayed at the start, at the end of the spraying process or in the middle of the spraying process intermittently also alone.

The gradient may have for example a non-linear configuration.

The concentration of the film-forming coating agent increases for example exponentially or with another function, the concentration of the further substance decreases exponentially or with another function, or vice versa.

The gradient may have for example a stepwise configuration.

The concentration of the film-forming coating agent increases stepwise, the concentration of the further substance decreases stepwise, or vice versa.

The variation in the sprayed amounts of the individual portions can be achieved for example by spraying one individual portion in a constant amount while the other individual portion is sprayed in amounts which increase or in amounts which decrease over time. It is likewise possible for example also to spray an individual portion in increasing amount while a decreasing amount of the other individual portion is sprayed.

It will be appreciated by the skilled worker that said types of gradient are mentioned only by way of example and can be combined or modified in many different ways.

Equipment

The method is particularly preferably carried out with drum coaters, coating pans, fluidized bed apparatuses or spray sifters comprising as spray device one or more three-fluid nozzles, in particular as fixed installation.

Coated Food Supplements or Pharmaceuticals

Coated pharmaceuticals or parts of pharmaceuticals or food supplements or parts thereof can be produced or obtained by means of the method of the invention. The sprayed individual portions are mixed together within fractions of seconds during the spray application and, through the evaporation of the water which proceeds virtually simultaneously, form a polymer matrix on the surface of the substrates. The resulting molecular matrix structure should therefore differ from a matrix structure produced when both film-forming coating agents is present in a polymer dispersion before the spraying. Despite this difference, no adverse effects compared with conventional methods are found in the quality of the coating, e.g. gloss or uniformity.

Dispersions

The film-forming coating agent is preferably in the form of sprayable dispersions. The dispersions may comprise for example a solids content of from 10 to 60, preferably 20 to 40, % by weight (meth)acrylate copolymer. Finely dispersed in water, the (meth)acrylate copolymers are in the form of particles with particle sizes in the range of, for example, 5 nm-30 μm. The dispersions are in each case stable as such. On removal of water by drying after the spraying, the particles coalesce and afford continuous (meth)acrylate copolymer coatings on the respective substrate.

Excipients Customary in Pharmacy

Plasticizers: Substances suitable as plasticizers ordinarily have a molecular weight between 100 and 20 000 and contain one or more hydrophilic groups in the molecule, e.g. hydroxyl, ester or amino groups. Citrates, phthalates, sebacates, castor oil are suitable. Examples of suitable plasticizers are alkyl citrates, propylene glycol, glycerol esters, alkyl phthalates, alkyl sebacates, sucrose esters, sorbitan esters, diethyl sebacate, dibutyl sebacate and polyethylene glycols 4000 to 20 000. Preferred plasticizers are tributyl citrate, triethyl citrate, acetyl triethyl citrate, dibutyl sebacate and diethyl sebacate. The amounts used are between 1 and 20, preferably 2 to 10, % by weight based on the (meth)acrylate copolymer.

Emulsifiers

If emulsifiers are present in the coating agents, they should be toxicologically acceptable. In principle, nonionic emulsifiers are preferred for pharmaceuticals.

Suitable classes of emulsifiers are ethoxylated fatty acid esters or ethers, ethoxylated sorbitan ethers, ethoxylated alkylphenols, glycerol esters or sugar esters or wax derivatives.

Examples of suitable emulsifiers are polyoxyethylene glycerol monolaurate, polyoxyethylene glycerol monostearate, polyoxyethylene 25 cetylstearate, polyoxyethylene(25)oxypropylene monostearate, polyoxyethylene 20 sorbitan monopalmitate, polyoxyethylene 16 tert-octylphenol, polyoxyethylene 20 cetyl ether, polyethylene glycol (1000) monocetyl ether, ethoxylated castor oil, polyoxyethylene sorbitol wool wax derivatives, polyoxyethylene (25) propylene glycol stearate, polyoxyethylene sorbitol esters polyoxyethylene 25 cetylstearate, polyoxyethylene 20 sobitan monopalmitate, polyoxyethylene 16 tert-octylphenol and polyoxyethylene 20 cetyl ether.

Dryers (non-stick agents): Dryers have the following properties: they have large specific surface areas, are chemically inert, are free-flowing and comprise fine particles. Because of these properties, they can advantageously be dispersed homogeneously in melts and reduce the tack of polymers containing highly polar comonomers as functional groups.

Examples of dryers are:

Alumina, magnesium oxide, kaolin, talc, silica (Aerosils), barium sulfate, carbon black and cellulose.
   Release Agents (Mold Release Agents)

Examples of release agents are:
esters of fatty acids or fatty amides, aliphatic, long-chain carboxylic acids, fatty alcohols and esters thereof, montan waxes or paraffin waxes and metal soaps; particular mention should be made of glycerol monostearate, stearyl alcohol, glycerol behenic acid ester, cetyl alcohol, palmitic acid, canauba wax, beeswax etc.

Further excipients: Mention should be made here of, for example, stabilizers, colorants, antioxidants, wetting agents, pigments, gloss agents etc. They are used in particular as processing aids and are intended can be to ensure a reliable and reproducible production process and good long-term storage stability. Further excipients customary in pharmacy may be present in amounts of from 0.001% by weight to 200% by weight, preferably 0.1 to 100, particularly preferably 5 to 50% by weight, based on the copolymer.

### EXAMPLES

Examples of spray solutions which can be employed according to the invention:

Spray liquid 1:

| | |
|---|---|
| EUDRAGIT ® L 30 D-55 | 300 g |
| (copolymer of 50% by weight ethyl | |
| acrylate and 50% by weight | |
| methacrylic acid) | |
| 1 N sodium hydroxide solution | 250 g |
| Water | 1050 g |

Production:

Sodium hydroxide solution (NaOH) is put with stirring into the EUDRAGIT® dispersion diluted with water and stirred until dissolved. The pH is about 5.5.

Spray liquid 2:

| | |
|---|---|
| EUDRAGIT ® L 30 D-55 | 300 g |
| 1 N sodium hydroxide solution | 250 g |
| Pigment suspension | 750 g |
| Water | 300 g |

Production:

Sodium hydroxide solution is put with stirring into the EUDRAGIT® dispersion diluted with water and stirred until dissolved. The pigment suspension is then added while stirring. The pH is about 6.

Composition of the pigment suspension:

| | |
|---|---|
| Talc | 100 g |
| Titanium dioxide | 50 g |
| Colored pigment | 50 g |
| Polyethylene glycol 6000 | 50 g |
| Trisodium citrate 5.5 hydrate | 62 g |
| Antifoam | 1 g |
| Water | 687 g |

Production:

The solids are dispersed in water using a homogenizer.

Spray liquid 3:
Polymer dispersion

| | |
|---|---|
| EUDRAGIT ® E PO | 12.0 g |
| (Copolymer of 25% by weight methyl | |
| methacrylate, 35% by weight butyl | |
| methacrylate and 50% by weight | |
| dimethylaminoethyl methacrylate | |
| with an average particle size of | |
| 15 μm) | |
| Sodium lauryl sulfate | 11.2 g |
| Stearic acid | 1.8 g |
| Water | 85.0 g |
| Total | 100.0 g |

Spray liquid 4:
E 100 solution from ring binder

| | |
|---|---|
| EUDRAGIT ® E 100 | 5.5 g |
| Acetone | 43.1 g |
| Isopropanol | 51.4 g |
| Total | 100.0 g |

Spray Liquid 5:

0.1 N hydrochloric acid

Spray Liquid 6:

Sodium citrate solution, 10% strength in water

Spray liquid 7:
EUDRAGIT ® L30 D-55 spray suspension

| a.) colorless | |
|---|---|
| EUDRAGIT ® L 30 D-55 | 49.4 g |
| Triethyl citrate | 3.0 g |
| Talc | 7.4 g |
| Antifoam emulsion | 0.1 g |
| Dem. water | 40.1 g |
| Total | 100.0 g |

b.) e.g. Pigment-Containing EUDRAGIT® L30 D-55 Spray Suspension

Composition of the pigment suspension:

| | |
|---|---|
| Talc | 10.7 g |
| Titanium dioxide | 5.3 g |
| Colored pigment | 5.3 g |
| Polyethylene glycol 6000 | 5.3 g |
| Antifoam | 0.1 g |
| Water | 73.3 g |
| Total | 100.0 g |

Production:

The solids are dispersed in water using a homogenizer and then stirred into the polymer dispersion.

Spray liquid 8:
Redispersed EUDRAGIT ® L100-55

| a.) | |
|---|---|
| EUDRAGIT ® L100-55 | 30.0 g |
| 1 N NaOH | 10.0 g |
| Dem. water | 60.0 g |
| Total | 100.0 g |

b.) pigment-containing spray suspension with EUDRAGIT® L 100-55 redispersed.

See formula for pigment suspension from spray liquid 7b.)

Spray liquid 9:
Spray suspension of EUDRAGIT ® NE 30 D (copolymer of 70%
by weight methyl methacrylate and 30% by weight ethyl acrylate)

| a.) colorless | |
|---|---|
| EUDRAGIT ® NE 30 D | 41.7 g |
| Talc | 12.25 g |
| Dem. water | 45.8 g |
| Total | 100.0 g |

Spray liquid 10:
Spray suspension of EUDRAGIT ® RL/RS 30 D

| a.) colorless | |
|---|---|
| EUDRAGIT ® RL 30 D or -RS 30 D | 46.3 g |
| Triethyl citrate | 2.8 g |
| Syloid 244 FP | 4.2 g |
| Antifoam emulsion | 0.1 g |
| Dem. water | 46.6 g |
| Total | 100.0 g |

b.) pigment-containing spray suspension with EUDRAGIT® L 100-55 redispersed.

See formula for pigment suspension from spray liquid 7b.)

Spray liquid 11:
Spray suspension of hydroxypropylcellulose (HPMC)

| | |
|---|---|
| Methocel ® E 5 Premium | 10.0 g |
| Dem. water | 90.0 g |
| Total | 100.0 g |

1. A method for producing pharmaceuticals or parts of pharmaceuticals or food supplements or parts thereof,
comprising coating substrates for pharmaceutical applications or substrates for applications as food supplements for humans or animals with a film-forming coating agent which is mixed with at least one further substance suitable for said purposes,
where the film-forming coating agent and the further substance are initially present separate from one another as liquid, sprayable individual portions in the form of a solution or dispersion, and
are sprayed by means of one or more spray devices which have, singly or together, at least two separate nozzles for liquids, and their spray beams overlap,
in such a way that the individual portions sprayed from the separate nozzles are mixed during the spraying process, the mixture impinges on the substrate and forms thereon, after evaporation of the liquid, a continuous film coating, resulting in the pharmaceutical, the food supplement or the part thereof, wherein
the amounts of the individual portions are varied during the spraying process so that the coating agent and the further substance are present in a concentration gradient from the inside to the outside relative to the dried film coating.

2. The method as claimed in claim 1, wherein the substrates for pharmaceutical applications are active ingredient crystals, active ingredient-containing cores, tablets, granules, pellets, capsules or parts of capsules.

3. The method as claimed in claim 1, wherein the film-forming coating agent is a cellulose derivative or a (meth)acrylate copolymer which may where appropriate comprise further pharmaceutical excipients.

4. The method as claimed in claim 1, wherein the further substance is an acid, a base, a plasticizer, a release agent, a pigment, a stabilizer, an antioxidant, a further film-forming coating agent or an active pharmaceutical ingredient or a mixture thereof.

5. The method as claimed in claim 1, wherein a substrate which comprises an acid-sensitive active ingredient is coated with a gradient of a coating agent which is (meth)acrylate copolymer comprising anionic groups which are wholly or partly neutralized, and of a further substance which is a (meth)acrylate copolymer comprising anionic groups which is neutralized less than the first-mentioned, or not at all, where the concentration of the further substance increases from the inside to the outside.

6. The method as claimed in claim 1, wherein a substrate which comprises an acid-sensitive active ingredient is coated with a gradient of a coating agent which is (meth)acrylate copolymer comprising anionic groups, and of a further substance which is a base, where the concentration of the base decreases from the inside to the outside.

7. The method as claimed in claim 5, wherein the acid-sensitive active ingredient is a protein, a peptide or a proton pump blocker.

8. The method as claimed in claim 7, wherein the active ingredient is omeprazole, esomeprazole, lanzoprazole, rabeprazole, pantoprazole.

9. The method as claimed in claim 1, wherein a substrate which comprises an alkali-sensitive active ingredient is coated with a gradient of a coating agent which is (meth)acrylate copolymer comprising amino groups, which is wholly or partly neutralized, and of a further substance which is a (meth)acrylate copolymer comprising amino groups, which is neutralized less than the first-mentioned, or not at all, where the concentration of the further substance increases from the inside to the outside.

10. The method as claimed in claim 1, wherein a substrate which comprises an alkali-sensitive active ingredient is coated with a gradient of a coating agent which is (meth)acrylate copolymer comprising amino groups, and of a further substance which is an acid, where the concentration of the acid decreases from the inside to the outside.

11. The method as claimed in claim 9, wherein the alkali-sensitive active ingredient is an analgesic, antihistamine, a protein, a peptide.

12. The method as claimed in claim 11, wherein the active ingredient is acetylsalicylic acid, ranitidine or famotidine or salt thereof or a stereoisomer thereof.

13. The method as claimed in claim 1, wherein a substrate which comprises an active ingredient sensitive to a pigment is coated with a gradient of a coating agent which is a (meth)acrylate copolymer which comprises no or amounts of the pigment which are only non-critical for the active ingredient, and of a further substance which is a pigment in an amount harmful for the active ingredient and may, where appropriate, in turn be mixed with a (meth)acrylate copolymer, where the concentration of the pigment increases from the inside to the outside.

14. The method as claimed in claim 13, wherein the pigment-sensitive active ingredient is acetylsalicylic acid or ascorbic acid.

15. The method as claimed in claim 1, wherein a substrate is coated with a gradient of a coating agent which is (meth)acrylate copolymer and comprises 10 to 50% by weight of a plasticizer, and of a further substance which is a (meth)acrylate copolymer and comprises no or less than 10% by weight of a plasticizer, where the concentration of the further substance increases from the inside to the outside.

16. The method as claimed in claim 15, wherein the substrate comprises active ingredient-containing granules, pellets or active ingredient crystals.

17. The method as claimed in claim 1, wherein two or more two-fluid nozzles or one or more three-fluid nozzles are employed as spray device.

18. The method as claimed in claim 1, wherein the spray application takes place in a drum coater, a coating pan, a fluidized bed apparatus or a spray sifter.

19. The method as claimed in claim 18, wherein the spray application takes place by means of spray devices as fixed installation.

20. A pharmaceutical or part of a pharmaceutical, food supplement or part thereof, produced by a method as claimed in claim 1.

21. A drum coater, coating pan, fluidized bed apparatus or spray sifter suitable for carrying out a method as claimed in claim 1, comprising one or more three-fluid nozzles as spray device.

22. (canceled)

23. The method as claimed in claim 6, wherein the acid-sensitive active ingredient is a protein, a peptide or a proton pump blocker.

24. The method as claimed in claim 23, wherein the active ingredient is omeprazole, esomeprazole, lanzoprazole, rabeprazole, pantoprazole.

25. The method as claimed in claim 10, wherein the alkali-sensitive active ingredient is an analgesic, antihistamine, a protein, a peptide.

26. The method as claimed in claim 25, wherein the active ingredient is acetylsalicylic acid, ranitidine or famotidine or salt thereof or a stereoisomer thereof.

27. The method as claimed in claim 1 comprising employing one or more spray devices.
